(19) United States
(12) Patent Application Publication
(10) Pub. No.: US 2014/0154115 A1
(43) Pub. Date: Jun. 5, 2014

(54) Scroll Compressor Having A Single Phase Induction Motor With Aluminum Windings

(71) Applicant: EMERSON ELECTRIC CO., St. Louis, MO (US)

(72) Inventors: Matthew Paul Bingaman, Dardenne Prairie, MO (US); John Patrick Powers, St. Louis, MO (US)

(73) Assignee: EMERSON ELECTRIC CO., St. Louis, MO (US)

(21) Appl. No.: 13/835,087

(22) Filed: Mar. 15, 2013

Related U.S. Application Data
(60) Provisional application No. 61/731,618, filed on Nov. 30, 2012.

(51) Int. Cl. H02K 3/02; H02K 17/16; F04C 23/02

(52) U.S. Cl. CPC H02K 3/02; F04C 23/02; H02K 17/16
USPC 417/410.5

(57) ABSTRACT

A scroll compressor system for compressing a refrigerant, the scroll compressor comprising a single phase motor which includes a stator having a stator core that defines a plurality of slots positioned radially about an interior of the stator core and windings located within the plurality of slots. The windings including a main winding and a start winding and each of the main and start winding are formed from a conducting wire that includes aluminum. The compressor includes a rotor disposed concentrically within the stator, a drive shaft coupled to the rotor, and an orbital scroll member coupled to the drive shaft. The single phase motor, drive shaft, and orbital scroll member located with the shell.

### CROSS-REFERENCE TO RELATED APPLICATION

This application claims the benefit of U.S. Provisional Application No. 61/731,618, filed on Nov. 30, 2012. The entire disclosure of the above application is incorporated herein by reference.

### FIELD

The present disclosure relates to a scroll compressor having a single phase induction motor with aluminum windings.

### BACKGROUND

This section provides background information related to the present disclosure which is not necessarily prior art.

Refrigeration and air conditioning systems generally include a compressor, a condenser, an expansion valve or its equivalent, and an evaporator. These components are coupled in sequence to define a continuous flow path. A refrigerant flows through the system and alternates between a liquid phase and a vapor or gaseous phase. A variety of compressor types have been used to implement refrigeration systems, including, but not limited to, reciprocating compressors, screw compressors, and rotary compressors, such as vane type compressors, for example.

An electric motor drives one of the scroll members via a suitable drive shaft affixed to the motor rotor. Traditionally, compressor manufacturers used copper windings in their motors. More recently, manufacturers of scroll compressors have transitioned to motors having a combination of copper windings with some aluminum windings. Aluminum windings, however, have a higher resistivity than copper. Thus, replacing too many of the copper windings with aluminum windings will cause a decrease in the efficiency of the motor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### SUMMARY

This section provides a general summary of the disclosure, and is not a comprehensive disclosure of its full scope or all of its features.

A scroll compressor system for compressing a refrigerant, the scroll compressor comprising a single phase motor which includes a stator having a stator core that defines a plurality of slots positioned radially about an interior of the stator core and windings located within the plurality of slots. The windings including a main winding and a start winding. Both the main winding and start winding are formed from a conducting wire that includes aluminum. The compressor includes a rotor disposed concentrically within the stator, a drive shaft coupled to the rotor, and an orbital scroll member coupled to the drive shaft. The single phase motor, drive shaft, and orbital scroll member located with the shell.

### DRAWINGS

The drawings described herein are for illustrative purposes only of selected embodiments and not all possible implementations, and are not intended to limit the scope of the present disclosure.

FIG. 1 is a cross sectional view of an example of a scroll compressor.

FIG. 2 is a perspective view of the stator core and windings.

FIG. 3 is a top view of one embodiment of the stator core.

FIG. 4 is a cross sectional view of an exemplary winding configuration of a single phase motor.

FIG. 5 is a cross sectional view of the stator core with windings positioned within the slots.

FIG. 6 is an exploded view of empty slot.

FIGS. 7a and 7b are an exploded view of the slots of FIG. 5.

FIGS. 8a and 8b are cross sectional views of two exemplary rotor designs

FIG. 9 is a table showing various motor parameters

FIG. 10 is a dyne test graph of one embodiment of the motor compared to all copper motor.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

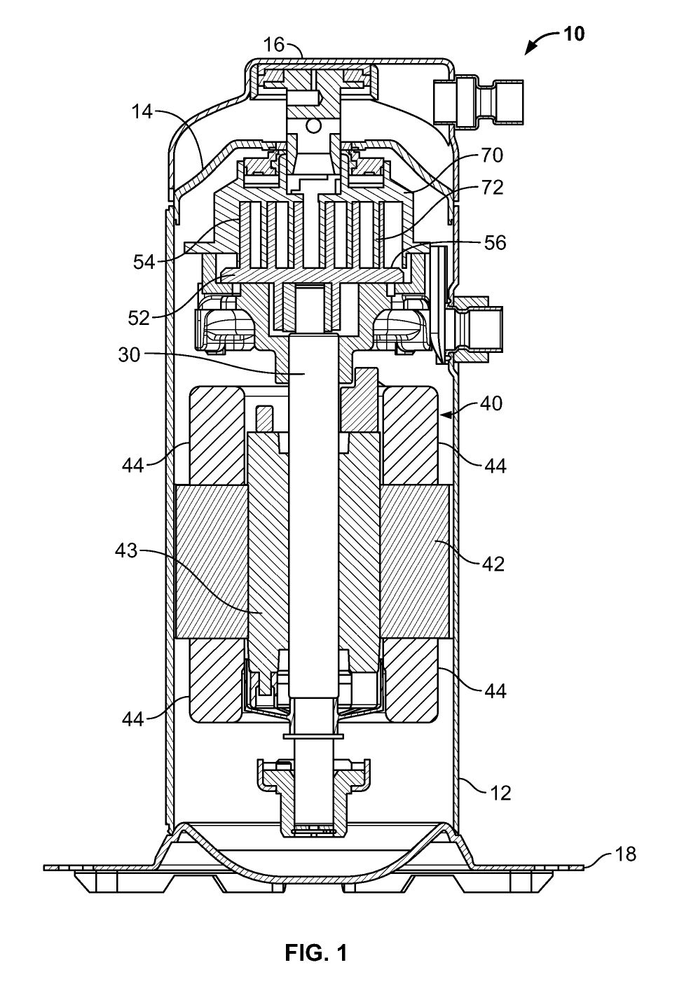

Referring now to the drawings and in particular, FIG. 1, a scroll compressor, generally indicated by 10, comprises a generally cylindrical shell 12, a partition 14 connected to an upper end of the shell, a lid 16 connected to the partition 14 and a base 18 connected to a lower end of the shell 12. Within the cylindrical shell 12, a single phase motor 40 is configured to drive an orbital scroll member 52. The motor 40 includes a stator assembly 42, windings 44 wound about the stator assembly 42, and a rotor 43 coupled to a drive shaft 30.

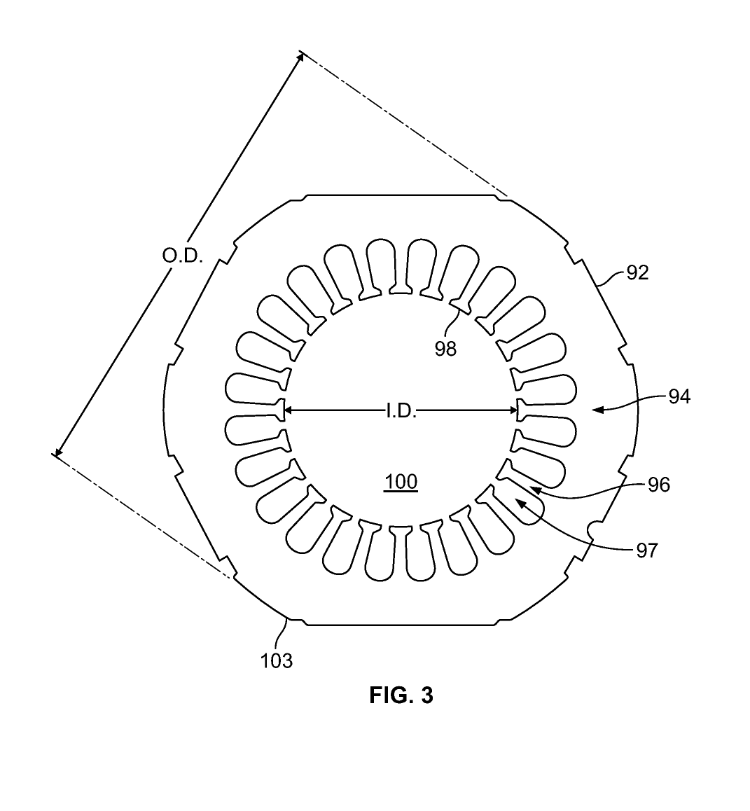

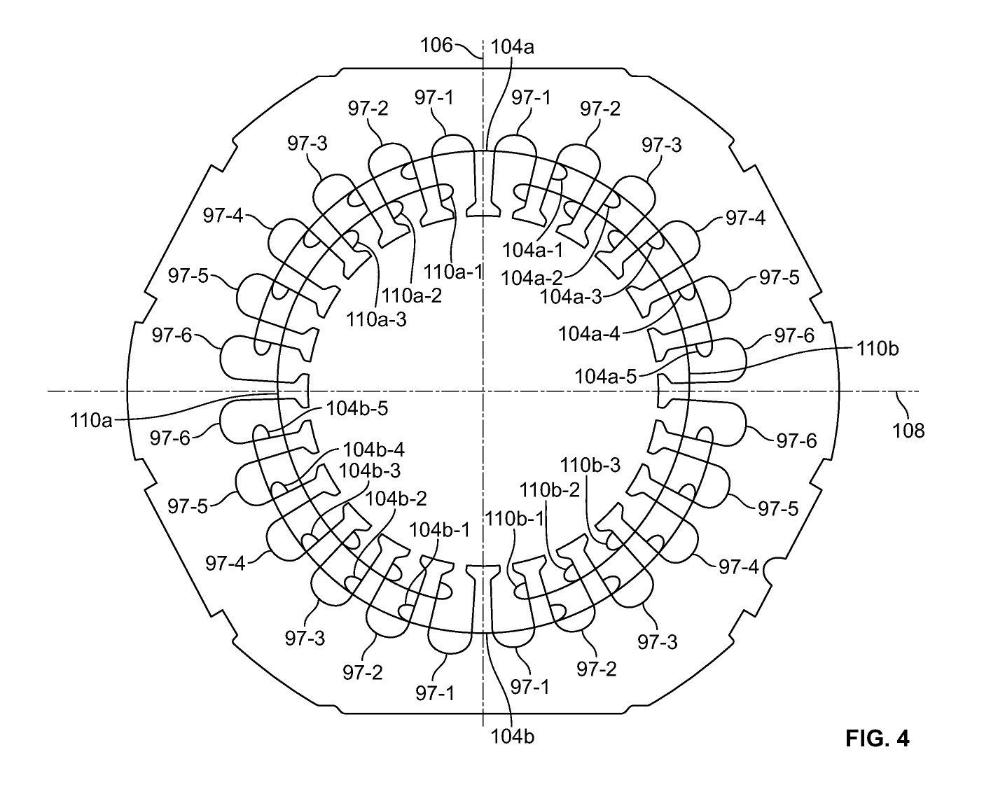

The motor 40 is a single phase, induction motor having a start winding 110 and a main winding 104 (FIG. 4). Both the start winding 110 and main winding 104 are formed by looping conducting wire about a plurality of teeth 96 (FIG. 3). For each of the main winding 104 and the start winding 110, the conducting wire includes aluminum and does not include copper. As used herein, aluminum should be understood to also include suitable aluminum alloys used as conducting wire to form motor windings. Generally, various embodiments of the motor 40 described herein have a standard operating voltage range between about 180V and about 300V, an operating power range above 1000 watts, a horse power rating greater than or equal to one Hp, and an efficiency greater than or equal to 80%. Having an efficiency rating greater than 80% allows the motor 40 to be used in the scroll compressor instead of similar motors with only copper windings or with both copper and aluminum windings. As used herein with voltages, the term about shall mean plus or minus 5V. As used herein with dimensions, he term about shall mean plus or minus 0.05 inches.

The motor 40 communicates mechanical energy to the orbiting scroll member 52 via the drive shaft 30. The orbital scroll member 52 has a spiral vane 54 extending upward from an end plate 56. Non-orbiting scroll member 70 is also provided with a vane 72 extending downward in meshing engagement with the orbital scroll member 52. The interaction between the scroll members 52, 70 may broadly be defined as a pump.

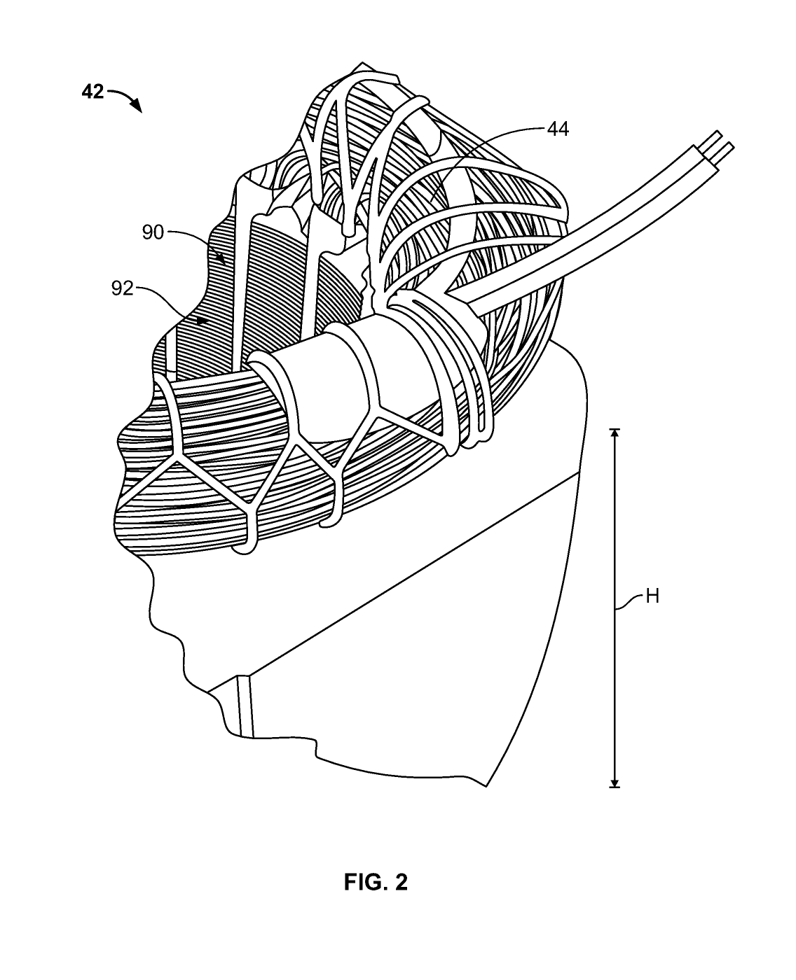

FIG. 2. is an example of the stator assembly 42 used within the scroll compressor assembly 10. The stator assembly 42 includes stator core 90 comprising stacked laminations 92. The stator core 90 has a stack height H. Depending on the embodiment of the scroll compressor, stack heights H may vary between 4.25 and 5.5 inches. With preferred embodiments having stack heights of 4.25 and 5.125 inches, respectively.

FIG. 3 illustrates an example of top view of the stator core 90 described above. The stator core 90 includes a yoke portion 94 and the plurality of teeth 96 extending radially inward from the yoke portion 94. The plurality of teeth 96 define the boundaries of a plurality of winding slots 97 each located between adjacent teeth 96. Collectively, interior ends 98 of the plurality of teeth 96 define a bore 100 that receives the rotor 43 (FIG. 1). Each slot has a proximate end, nearest the bore 100, and a distal end, radially distant from the bore 100. It should be understood that while the teeth 96 and the winding slots 97 have been illustrated as being equally spaced circumferentially about the stator core 90, various other known teeth and slot configurations may be used. The bore 100 defines an interior diameter generally referred to as I.D., and the outside edge of the yoke portion 96 defines an outer perimeter 103. The outer perimeter having an outer diameter which is generally referred to as the O.D. In one example of the motor 40 having a 1.5 horse power rating, the O.D. measures about 5.3 inches. Another example of the motor 40 having a 3 horse power rating, the O.D. measures about 6.3 inches. Other embodiments may have smaller or larger O.D. measurements.

FIG. 4 illustrates an example winding configuration of the single phase motor 40. The motor 40 includes the main winding 104, which is divided into two opposing sections 104a and 104b, and the start winding 110, which divided into two opposing sections 110a and 110b. Collectively, main winding sections 104a and 104b form the motor's two main poles. Referring now to main winding section 104a, main winding coil 104a-1 is located within slot pair 97-2; where each slot in slot pair 97-2 opposes the other. Similarly, main winding coils 104a-2, 104a-3, 104a-4, and 104a-5 are located, respectively, in slot pairs 97-3, 97-4, 97-5, and 97-6. Main winding coils 104a-3, 104a-4, and 104a-5 are, respectively, the only winding coils located in slot pairs 97-4, 97-5, and 97-6. In the embodiment illustrated in FIG. 4, each of the main winding coils 104a-1, 104a-2, 104a-3, 104a-4, and 104a-5 are located at the distal end of their respective slots away from the bore 100 relative to the start winding 110. Alternatively, in some arrangements, each of the main winding coils 104a-1, 104a-2, 104a-3, 104a-4, and 104a-5 may be located in the slots proximate the bore 100 relative to the start winding 110. While not described in detail, it should be understood that main winding section 104b-1 though 104b-5 are similarly positioned within slots 97-2 though 97-5 on the opposite side of the stator core 90.

Start winding sections 110a and 110b collectively form two starting poles for the motor 40. Referring now to start winding 110a, start winding coil 110a is positioned within slot pair 97-1; where each slot in slot pair 97-1 oppose each other. Similarly, start winding coils 110a-2 and 110a-3 are located, respectively, in slot pairs 97-2 and 97-3. While start windings 110a-2 and 110a-3 share slot pairs 97-2 and 97-3 with the main winding coils located in these slots, start winding coil 110a-1 is the only winding coil located with slots 97-1. While not described in detail, it should be understood that the start windings 110b-1 though 110b-3 of the other start winding coil 110b are similarly located in slots 97-1 through 97-3 on the opposite side of the stator core 90.

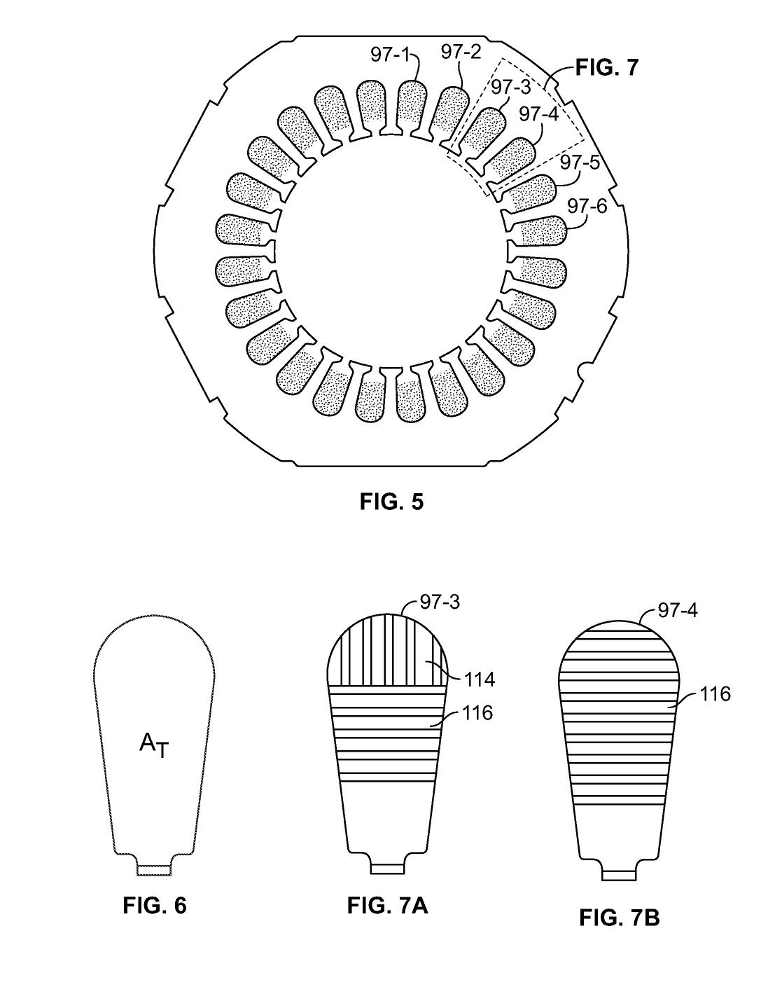

FIG. 5 illustrates a cross sectional view of the stator core 90 with the main windings 104 and start windings 110 positioned within the slots 97. Slots 97 each have a total cross sectional area A_{T}. The total cross sectional area A_{T} is the bounded area between two adjacent teeth (shown in FIG. 6). Slot 97-1 houses only the start windings. Slots 97-2 and 97-3 are shared slots that house both the main winding coil and the start winding coil (shown in FIG. 7a) and slots 97-4, 97-5, and 97-6 each house only one of the main winding coils (shown in FIG. 7b).

FIGS. 7a and 7b illustrate an expanded view of slots 97-3 and 97-4, respectively, as shown in FIG. 5. Slot 97-2 is an example of a shared slot that houses both the main winding and the start winding. Thus, the description provided for slot 97-2 is generally applicable to 97-3. Likewise, slot 97-4 houses only the main winding. Thus, the description provide for slot 97-4 is generally applicable to slots 97-5 and 97-6. Referring now to FIG. 7a, a vertically hashed area 114 represents the cumulative area of start winding 110—this area is the sum of the cross sectional areas of each conducting wire comprising the start winding 110 and is generally referred to as A_{sw}. A horizontally hashed area 116 represents the cumulative area of the main winding 104—this area is the sum of the cross sectional areas of each conducting wire comprising the main winding 104 and is generally referred to as A_{mw}. Adding A_{mw} and A_{sw} (if any start winding is in the slot) yields a total area of winding within chosen slot—this area is generally referred to as A_{w}. Referring now to FIG. 7b, slot 97-4 may house only the main winding 104. Thus, A_{mw} equals A_{w}.

The ratio of A_{w}/A_{T} defines the ratio of total winding area to total available slot area. As used herein, the ratio of A_{w}/A_{T} shall also be known as the slot fill ratio. In one preferred embodiment, the slot fill ratio is greater than or equal to 0.66 for slots 97-2 through 97-6. In another preferred arrangement, the slot fill ratio is: i) greater than or equal to 0.66 for slots 97-2 and 97-3 and ii) greater than or equal to 0.68 for slots 97-4, 97-5, and 97-6.

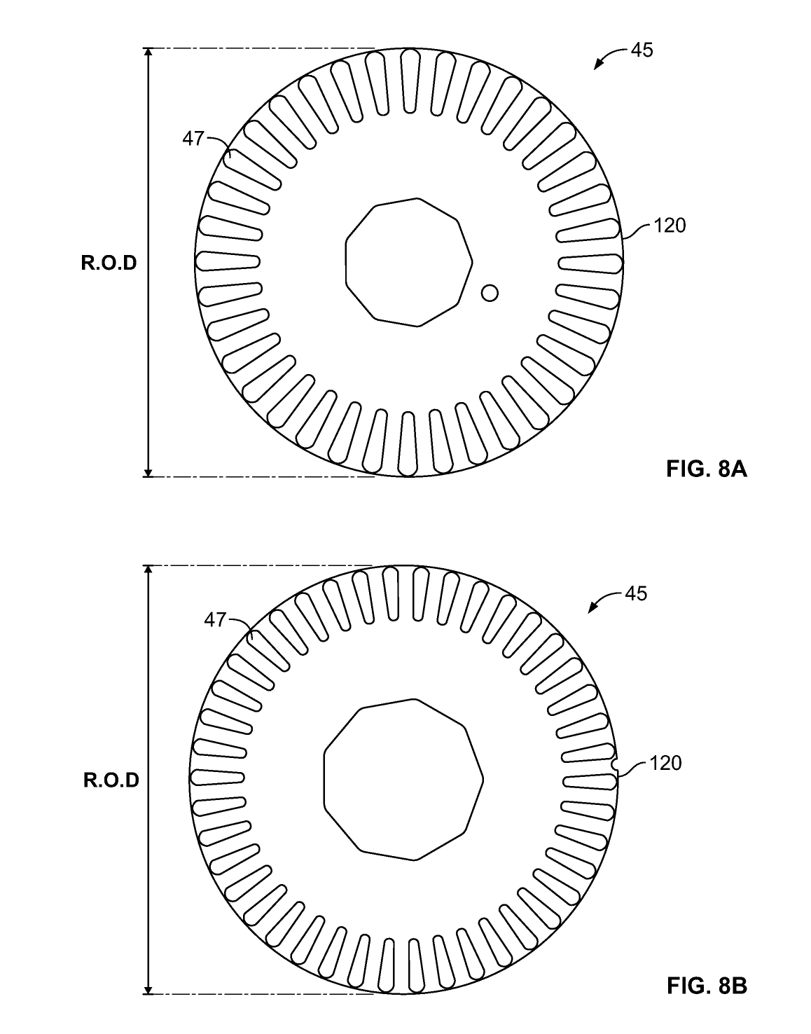

FIGS. 8a and 8b illustrate two exemplary cross sectional views of two embodiments of the rotor 43. In both examples, the rotor 43 has a rotor outer diameter R.O.D and defines an outer periphery 120. Aluminum induction bars 47 are evenly spaced about the rotor's outer periphery 120. By increasing the number of induction bars 47 within the rotor 43—as compared to the number of induction bars in rotors of equivalent motors with all copper windings or with combination copper and aluminum windings—the motor 40 garnered modest increases in efficiency. Referring now to the rotor 43 illustrated if FIG. 8a, the rotor 43 includes thirty-six (36) aluminum induction bars 47 equally spaced about its outer periphery 120. The R.O.D. is about 2.797 inches. This rotor is an example of one used on a 1½ hp motor. Referring now to the rotor 43 illustrated if FIG. 8b, the rotor 43 includes forty-two (42) aluminum induction bars 47 equally spaced about its outer periphery 120. The R.O.D. is about 3.074 inches. This rotor is an example of a rotor used on a 3 hp motor. While FIGS. 8a and 8b include specific induction bar numbers, depending on the embodiment, induction bar counts between 34 and 42 induction bars have been found to achieve motor efficiencies above 80%.

One preferred embodiment of the motor 40 having a 1½ Hp rating includes i) the stator core 90 having the stack height H equal to about 4¼ inches and the O.D. equal to about 5.3 inches and ii) the rotor 43 having R.O.D equal to about 2.797 inches and including thirty-six (36) induction bars. Another preferred embodiment of the motor 40 having a 3 Hp rating includes i) the stator core 90 having stack height H equal about 5⅛ inches and the O.D. equal to about 6.3 inches and ii) the rotor 43 having R.O.D equal to about 3.074 inches and including forty-two (42) induction bars. Both of these motor embodiments achieved efficiencies greater than 80% in voltage ranges between 180V and 300V.

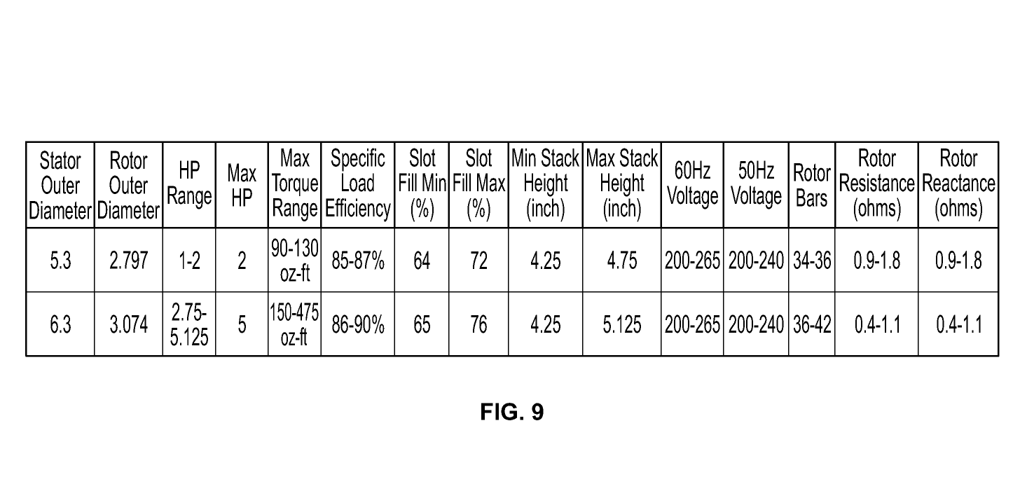

FIG. 9 is a table showing ranges of various parameters that may be chosen to produce the single phase motor 40 with its efficiency above 80%. The table in FIG. 9 was created using the stator having 24 slots. Referring now to row 117, when the O.D. is fixed at about 5.3 inches and the R.O.D. is fixed at about 2.797 inches, choosing i) the slot fill ratio to be a ratio between 0.64 and 0.72; ii) the stack height H to be a height between 4.25 inches and 4.75 inches; iii) the operating voltage to be a voltage between 200V and 265V at 60 Hz or 200V and 240V at 50 Hz; iv) the number of rotor bars 47 to be between 34 and 36; and v) the rotor resistance and reactance to be a resistance and reactance between 0.9 ohms and 1.8 ohms will produce a motor 40 having efficiency greater than 80%, specifically between 85% and 87%, with a horsepower range between 1 Hp and 2 Hp.

Similarly, Referring now to row 119, when the O.D. is fixed at about 6.3 inches and the R.O.D. is fixed at about 3.074 inches, choosing i) the slot fill ratio to be a ratio between 0.65 and 0.76; ii) the stack height H to be a height between 4.25 inches and 5.125 inches; iii) the operating voltage to be a voltage between 200V and 265V at 60 Hz or 200V and 240V at 50 Hz; iv) the number of rotor bars 47 to be between 36 and 42; and v) the rotor resistance and reactance to be the resistance and the reactance each between 0.4 and 1.1 ohms will produce a motor 40 having efficiency greater than 80%, specifically between 86% and 90%, with a horsepower range between 2.75 Hp and 5.125 Hp.

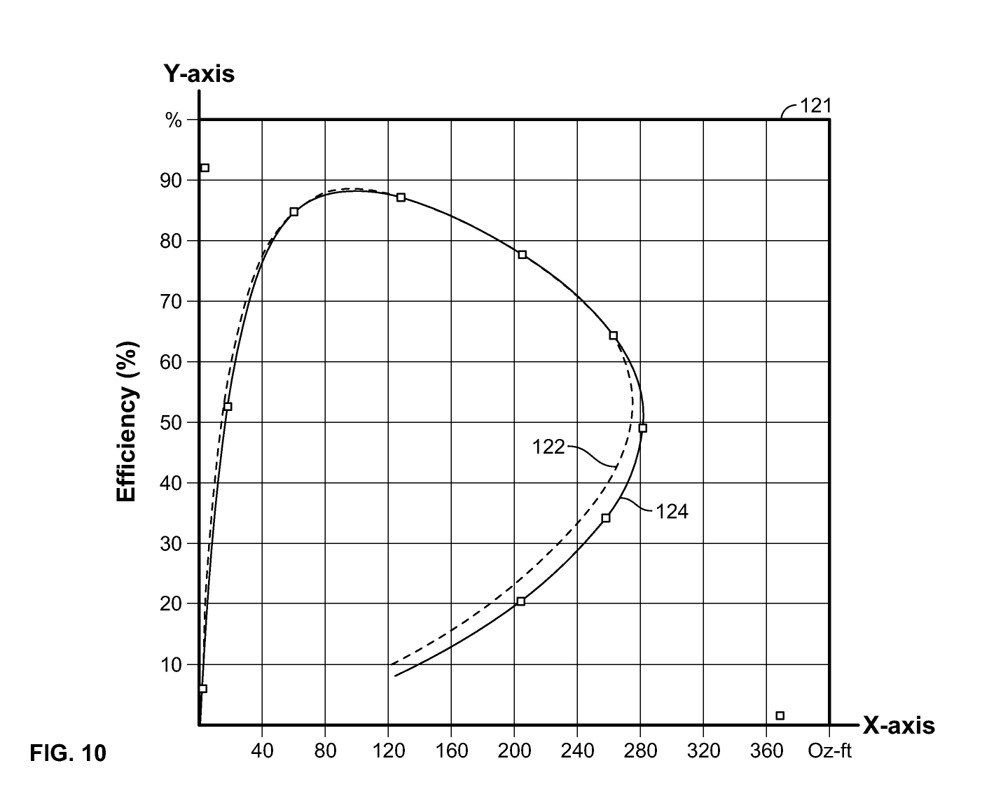

FIG. 10 illustrates a dyne test graph 121 of one embodiment of the motor 40 of the present disclosure compared to an equivalent motor with all copper windings. The term “equivalent motor” should be understood to mean the compared motors have roughly equivalent outer diameters O.D., inner diameters I.D, slots, operating voltage, operating frequency, and horse power rating. Stack heights H, the number of induction bars, and other parameters of the motors may be different.

The x-axis of the dyne test graph 121 represents the motor torque as measured in ounce-feet. The y-axis of the dyne test graph 121 represents the machine efficiency measured in percent (%). Line 122 is a test curve representing the single phase motor with winding formed from a conducting wire that includes aluminum and no copper. Line 124 is a test curve representing an equivalent single phase motor with windings formed from a conducting wire that includes copper. Parameters of the two motors 122 and 124 are listed in the following table:

| | Motor (122) | Motor (124) |
|---|---|---|
| Start Winding Material | Al | Cu |
| Main Winding Material | Al | Cu |
| Horse Power Rating | 3 Hp | 3 Hp |
| Operating Voltage | 230 V | 230 V |
| Operating Frequency | 60 Hz | 60 Hz |
| Slots | 24 | 24 |
| Stack Height | 5⅛″ | 4¼″ |
| Induction Bars in Rotor | 42 | 36 |
| Outer Diameter (O.D.) | 6.336″ | 6.336″ |

As the dyne test graph 121 shows, the motor 122 has a machine efficiency of about 88% at about 95 oz-ft of torque. This is about equal to the machine efficiency of the copper motor 124 at the same torque. While a dyne test graph for every combination of aluminum single phase motors disclosed is not provided, it should be understood that other embodiments of the all aluminum single phase motor of the present disclosure have machine efficiencies greater than to 80%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A scroll compressor system for compressing a refrigerant, the scroll compressor comprising:
a single phase motor comprising:
a stator having a stator core defining a plurality of slots positioned radially about an interior of the stator core and windings located within the plurality of slots, the windings include a main winding and a start winding and each of the main winding and start winding are formed from a conducting wire that includes aluminum; and
a rotor disposed concentrically within the stator;
a drive shaft coupled to the rotor;
an orbital scroll member operably coupled to the drive shaft; and
a shell, wherein the single phase motor, drive shaft, and orbital scroll member are located with the shell.

2. The scroll compressor of claim 1 wherein the stator core has a stack height in a range between 4¼ inches and 5½ inches.

3. The scroll compressor claim 1 wherein the stator core has a stack height of 4¼ inches.

4. The scroll compressor of claim 1 wherein the stator core has a stack height of 5⅛ inches.

5. The scroll compressor of claim 2, wherein a portion of the plurality of slots house both the main winding and the start winding, each slot of the portion of the plurality of slots that house both the main winding and the start winding has a total cross sectional area and an area filled with both windings, a ratio of the area filled with both windings to the total cross sectional area of the slot is greater than or equal to 0.66.

6. The scroll compressor of claim 2, wherein a portion of the plurality of slots house only the main winding, each slot of the portion of the plurality of slots that house only the main winding has a total cross sectional area and an area filled with the main winding, a ratio of the area filled with main winding to the total cross sectional area of the slot is greater than or equal 0.68.

7. The scroll compressor of claim 2 wherein the rotor includes an outer periphery and aluminum bars, numbering in a range between 34 and 42, evenly spaced about the outer periphery.

8. The scroll compressor of claim 1, wherein the single phase motor has an operating voltage range between 180 and 300 volts.

9. The scroll compressor of claim 1, wherein the single phase motor has an operating power range above 1000 watts.

10. The scroll compressor of claim 1, wherein the single phase motor has an efficiency greater than 80%.

11. A scroll compressor, the scroll compressor comprising:
a compression unit; and
a single phase motor driving the compression unit, the single phase motor comprising:
a stator having a stator core that includes a stack height chosen to be a height between 4.25 inches and 4.75 inches, the stator core defining plurality of slots positioned radially about an interior of the stator core and windings located within the plurality of slots, the windings include a main winding and a start winding and each of the main winding and start winding are formed from a conducting wire that includes aluminum;
a slot fill ratio chosen to be a ratio between 0.64 and 0.72; and
a rotor disposed concentrically within the stator, the rotor including an outer periphery and aluminum bars evenly spaced about the outer periphery, a number of aluminum bars chosen between 34 and 36.

12. The scroll compressor of claim 11, wherein the single phase motor has an operating voltage range between 200 and 265 volts.

13. The scroll compressor of claim 11, wherein the rotor resistance is between 0.9 and 1.8 ohms.

14. A scroll compressor, the scroll compressor comprising:
a compression unit; and
a single phase motor driving the compression unit, the single phase motor comprising:
a stator having a stator core that includes a stack height chosen to be a height between a height between 4.25 inches and 5.125 inches, the stator core defining plurality of slots positioned radially about an interior of the stator core and windings located within the plurality of slots, the windings include a main winding and a start winding and each of the main winding and start winding are formed from a conducting wire that includes aluminum;
a slot fill ratio chosen to be a ratio between 0.65 and 0.74; and
a rotor disposed concentrically within the stator, the rotor including an outer periphery and aluminum bars evenly spaced about the outer periphery, a number of aluminum bars chosen between 36 and 42.

15. The scroll compressor of claim 14, wherein the single phase motor has an operating voltage range between 200 and 265 volts.

16. The scroll compressor of claim 14, wherein the rotor resistance is between 0.4 and 1.1 ohms.

17. The scroll compressors of claims 11 and 14, wherein the plurality of slots has 24 slots.
